(19) United States
(12) Patent Application Publication
(10) Pub. No.: US 2017/0129798 A1
(43) Pub. Date: May 11, 2017

(54) METHOD FOR SEALING A DOUBLE-WALLED GLASS TUBE IN A VACUUM-TIGHT MANNER

(71) Applicant: Airbus Defence and Space GmbH, Taufkirchen (DE)

(72) Inventors: Jürgen STEINWANDEL, Uhldingen-Muehlhofen (DE); Helmut PIRINGER, Oberpframmern (DE); Stefan LAURE, Stuttgart (DE)

(21) Appl. No.: 15/413,500

(22) Filed: Jan. 24, 2017

Related U.S. Application Data
(63) Continuation of application No. PCT/EP2015/001266, filed on Jun. 24, 2015.

(30) Foreign Application Priority Data
Jul. 24, 2014 (EP) 14002568.5

(51) Int. Cl. C03B 23/13; C03C 17/22; F24J 2/05; C03B 23/043

(52) U.S. Cl. CPC C03B 23/13; C03B 23/043; C03C 17/22; F24J 2/055; C03C 2217/285; C03C 2218/15; C03C 2217/732

(57) ABSTRACT

This disclosure relates to a method and an apparatus for sealing a double-walled glass tube in a vacuum-tight manner, in particular a production method for manufacturing of solar collectors. By means of a vacuum chamber, inside of which a holding element is fixed and inside of which a heating conductor is arranged, an electro-conductively heating and a subsequent deforming of the double-walled glass tube can be achieved. No additional materials, such as metallic auxiliary element, solders are required. A simple installation inside the vacuum chamber is possible and a minimum vacuum feedthrough for the power supply of a heating conductor is required. The direct heat transfer onto the double walled glass tube and a resulting quick process control allows to reliably seal a double-walled glass tube of a thermal solar collector under vacuum with simple means.

### CROSS-REFERENCE TO RELATED APPLICATIONS

This is a continuation of International Application No. PCT/EP2015/001266, filed Jun. 24, 2015, which application claims priority to European Application No. 14002568.5, filed Jul. 24, 2014, which are hereby incorporated by reference in their entirety.

### TECHNICAL FIELD

This disclosure relates to solar collectors, which include double-walled glass tubes. In particular, the invention relates to a method for sealing a double-walled glass tube in a vacuum-tight manner and an apparatus for a vacuum-tight sealing of a double-walled glass tube.

### BACKGROUND

With thermal solar collectors, the most efficient system deploys a double-walled glass tube having an outer anti-reflection-layer, e.g. made of MgF₂. Liquid medium (water) to be heated will then be heated directly in the inner tube. The medium between the double wall serves for a thermal insulation. In an ideal case, this is a vacuum. In this procedure it is necessary to reliably seal a double-walled glass tube, which is already melted at one end, at the other, initially open end inside a vacuum chamber under a vacuum directly after the MgF₂ vapor deposition process.

According to the existing state of the art, the last method step for melting the double-walled glass tubes under vacuum is accomplished by means of a gas flame, heating by means of a laser as well as with the aid of glass solders. With the previously mentioned methods it is a disadvantage that, e.g., the flame methods are problematic to handle in a vacuum, in particular with respect to contaminations that are likely to occur consisting of combustion residues. In general, this leads to sealing problems. Laser methods are disadvantageous in that the focusing inside the vacuum recipients is cumbersome and cost-intensive. Furthermore, glass solders need to be heated from externally.

### SUMMARY

It may be considered an object of the invention to provide an improved method for vacuum-tightly sealing a double-walled glass tube, in particular in the manufacturing and production of solar collectors.

According to an exemplary embodiment, a method for sealing a double-walled glass tube in a vacuum-tight manner, the glass tube having an inner glass tube and an outer glass tube, is provided. The method comprises the step of providing the double-walled glass tube inside a vacuum chamber at a desired negative pressure inside the vacuum chamber. As a further step, the electro-conductive heating of the outer and/or the inner glass tube at a first end of the double-walled glass tube by means of at least one heating conductor is provided. In a third step, the electro-conductively heated glass tube is deformed at a first end of the double-walled glass tube, in particular permanently deformed, in a manner that the outer glass tube and the inner glass tube touch each other and that the first end of the double-walled glass tube is sealed in a gas-tight manner as a result.

With this, a method for vacuum-tightly sealing of a double-walled glass tube under vacuum/negative pressure conditions is provided, which is simple to handle, does not create any contaminations or combustion residues and is also unproblematic regarding common sealing problems with feeding of the respective components into the vacuum. The electro-conductive heating according to the present invention does not require additional materials, such as solders, metallic auxiliary elements for the laser process or the such. It allows a simple installation in the vacuum recipient, i.e. in the vacuum chamber, and only minimum vacuum feed-throughs for a power supply of the at least one heating element are required. A direct heat transfer onto the double-walled glass tube and a quick process control is enabled.

This method for vacuum-tightly sealing of a double-walled glass tube may particularly be a manufacturing process or a part of a manufacturing process for the production of solar collectors.

In an exemplary embodiment of the method, inside the vacuum chamber the space between the inner and the outer glass tube is evacuated. The at least one heating conductor is also present in the vacuum chamber and is installed therein. Of course, two or even more heating conductors or heating modules, respectively, may be used in this and in all other exemplary embodiments of the present invention. This aspect of the present invention will be explained in the following in more detail in the context of exemplary embodiments. Providing the heating conductor within the vacuum chamber allows the heating and the sealing of both glass tubes through direct application of the heating conductor onto a surface of the double-walled glass tube. Thereby, the heating conductor may be applied onto an inner and/or an outer surface of the glass tube. This allows the direct heat transfer onto the surface of the glass tubes. This contacting of the surface or the surfaces by means of the electro-conductive heating conductor may be accomplished directly after an evacuation process. If desired, the double-walled glass tube may rotate at the same time, such that an even heating is ensured. This is part of an exemplary embodiment, which will be explained in more detail in the following.

The deformation of the first end of the double-walled glass tube may exemplarily be accomplished through shifting the heating conductor used. However, also a shifting of the double-walled glass tube with an otherwise static, unmoved heating conductor is part of the invention. In case of using two heating conductors, e.g. two heating conductor halves as shown in FIG. 2, the deformation may be conducted through shifting of the respective heating conductor halves relative to each other in a perpendicular position. After reaching the desired deformation, the heating conductor may be removed from the double-walled glass tube, such that the cooling process can be established.

In case two heating conductors are used, they may be arranged in such a way, that a simultaneous heating of both tubes for heating the outer tube and the inner tube is accomplished. Besides that, according to a further exemplary embodiment, an additional possibility is given for vapor depositing absorption layers, e.g. anti-reflection coatings, in a separate chamber section. This method allows to reduce the evacuation times in general and, resultantly, a more economic production process. In other words, a double-walled glass tube, which is already melted at one end, is reliably sealed under a negative pressure/vacuum, if desired after or directly after a vapor deposition process, by means of a method according to the present invention. The previously mentioned vapor deposition process is an optional addition according to a further exemplary embodiment of the invention.

For example, the electro-conductive heating according to the present invention may be realized by means of one or a plurality of ceramic heat conductors, in particular with silicon infiltrated silicon carbide (SiSiC) heating conductors. In particular, such heating conductors may be designed in a manner that their contour receives the glass tube to be sealed in a form-fit manner. In other words, the double-walled glass tube may be enclosed through the heating conductor or the heating conductors partially or completely in its circumference and provides a heat transfer to the double-walled glass tube at the respective contacting surface.

In doing so, the process of deformation and sealing may merely last for some few seconds. However, it is also possible to conduct the method according to the invention over a longer period of time. Typical melting temperatures for glass for glass tubes, which are used in the field of solar collectors, range between 200 and 500° C. A heating of the double-walled glass tube into this range by means of the heating conductor is thus a part of the invention. A preferred temperature range, into which the double-walled glass tube may be brought by means of the heating conductor, is between 300° C. and 350° C. However, it is also possible that other materials, e.g. quartz glass, are used, through which the melting temperature may rise to 1000° C. Typically, a negative pressure of 10⁻² mbar or even lower pressures is used inside the vacuum chamber. However, it is also possible to use another pressure without departing from the scope of protection of the present invention.

For that matter it is possible to both heat only the outer glass tube or heat only the inner glass tube or the outer and also the inner glass tube electro-conductively. Referring to an exemplary embodiment of FIG. 2 it is shown how partial cylinders as heating conductors arranged from externally touch the outer tube of the double-walled glass tube and transfer heat energy to it. An illustrative representation can also be gathered from FIG. 3. However, it is also part of the invention to insert a heating conductor along the longitudinal axis into the double-walled tube and to contact the inner glass tube of the double-walled glass tube from inside, to heat it, deform it and seal the whole tube as a result. Also, a combination of both these heating and deforming options is a part of the present invention.

According to an exemplary embodiment, the heating conductor provided is guided/moved to the double-walled glass tube and heated by means of an electrical current. Due to the direct contact with the glass tube, the glass tube is heated and brought to its melting point. Through a relative motion between the glass tube and the heating conductor, the previously electro-conductively heated glass tube can be deformed, such that an air-tightly sealed end of the glass tube is created altogether. In other words, an electrical current is created inside the heating conductor, which leads to heating the heating conductor.

In this regard, the method may be conducted fully automated or also under by means of intervention of a user. For example, the double-walled glass tube may be inserted into the vacuum chamber, i.e. the recipient, manually, but also a fully automatic insertion into the vacuum chamber is possible.

According to a further exemplary embodiment of the invention, the electro-conductive heating and the deforming are accomplished through the at least one heating conductor inside the vacuum chamber.

In other words, the double-walled glass tube is not only heated through the heating conductor, but also deformed through it. For example, a heating conductor may be moved inside the vacuum chamber by means of a mechanical control, e.g. by means of a hydraulic lifting- or lowering device, on which the heating conductor is arranged directly or indirectly. This aspect regarding the movement of the heating conductor may exemplarily be gathered from the exemplary embodiments, that are exemplarily described in FIGS. 2 and 3.

According to a further exemplary embodiment of the invention, the method comprises the step of creating a relative motion between the double-walled glass tube and the heating conductor, wherein the deforming of the double-walled glass tube is caused at the first end.

In doing so, for example a translational motion of the heating element or the heating elements may serve that the outer glass wall of the double-walled glass tube is pressed in an inward direction onto the inner glass wall in its heated state. Such a translational motion of both heating conductors may exemplarily be gathered from FIGS. 2 and 3. However, it is also possible to accomplish a combination of rotational and translational movements through the heating conductor. Since it is a relative motion it is also possible that the heating conductor or the heating conductors are statically arranged during the method and that a respective device moves the double-walled glass tube, such that the deforming and the air-tight sealing at the glass tube resulting therefrom are created.

According to a further exemplary embodiment of the invention, at least two heating conductors are used in the method. Hereby, in this exemplary embodiment both heating conductors are realized as partial jackets for covering a part of the double-walled glass tube each. The method according to this exemplary embodiment therefore furthermore comprises the step of at least partially covering the outer glass tube by means of the first heating conductor and comprises the step of at least partially covering the outer glass tube by means of the second heating conductor. Through a shifting of both heating conductors perpendicular to a longitudinal axis of the double-walled glass tube for deforming and air-tightly sealing the electro-conductively heated glass tube, the desired sealing of the double-walled glass tube is accomplished.

Such a perpendicular shifting of both partially jacket-shaped heating conductors is clarified in the exemplary, non-limiting exemplary embodiment of FIG. 2. Here, a form-fit between both heating conductors and the outer glass tube of the double-walled glass tube is thus created, such that a particularly good heat transfer from the heating conductor to the glass tube is possible. This reduces the duration of the method and enables a particularly efficient sealing method.

The heating conductor or conductors of the present invention may be made from various materials. On the one hand, ceramic materials for the heating conductor or conductors suggest themselves. In particular, a silicon infiltrated silicon carbide (SiSiC) may be used. As an alternative to SiSiC, e.g. carbon fibre reinforced carbon (CFC) or carbon fibre reinforced silicon carbide may be used. Hereby, also the C-fibre may be replaced by a SiC-fibre. Densely sintered SiC as a heating conductor material are contemplable in general, but the current flow characteristics are not as particularly pronounced as the other mentioned characteristics.

As an alternative to the ceramic heating conductor materials, also metallic heating conductors may be used. For example, nickel and/or nickel base alloys, tantalum and/or tantalum base alloys, niobium and/or niobium base alloys. It is also a part of the invention to use mixtures of the previously mentioned materials.

According to a further exemplary embodiment of the invention, the heating conductor is formed of ceramics, in particular of silicon infiltrated silicon carbide (SiSiC).

The material SiSiC is preferably used according to this exemplary embodiment in the sealing method of the invention due to its good thermal conductivity. Also, the electric creation of heat in SiSiC is particularly advantageous in practice. SiSiC is a compound material consisting of a porous SiC base structure. In this structure, silicon is infiltrated in a metal fusion process, by means of which a non-porous homogeneous compound structure is achieved. This compound structure provides an excellent heat conductor according to experience and suits in a preferred manner this exemplary embodiment of the invention.

According to a further exemplary embodiment of the invention, the electro-conductive heating is accomplished through a direct application of the heating conductor onto a surface of the double-walled glass tube and after an evacuation process of the vacuum chamber.

According to a further exemplary embodiment of the invention, a volume, which is situated between the inner glass tube and the outer glass tube, is evacuated.

It is noted that rough vacuum conditions, i.e. about 0.01 mbar, are sufficient for the present invention. Lower pressures may of course also be used, if the user desires these and if they are necessary for the concrete application case. However, in general it is to be considered that the higher thermal insulation effect achieved thereby contradicts a cost-intensive fine or high vacuum process.

According to a further exemplary embodiment of the invention, a rotational movement between the inner and the outer glass tube relative to the heating conductor during the electro-conductive heating is created.

For example, it is possible to move the heating conductor around the static glass tube in a rotational motion. As an alternative it is also possible to arrange the heating conductor in the vacuum chamber in a static manner and to create a rotational motion of the glass tube. However, also a combination of both these rotational movements is possible.

For example, the double-walled glass tube may be put onto a roller guide, which is part of the apparatus according to the invention. This roller guide in this case is also placed in the vacuum chamber. The part of the tube, which is not heated by the heating conductor, may be placed on a roller guide for creating the rotation. An electric drive lets the roller guide rotate, such that a rotational motion of the double-walled glass tube relative to the at least one heating conductor is providable altogether. An appropriate control of a respective electronics of the apparatus according to the invention is also part of the present invention.

Due to the relative rotation between the at least one heating conductor and the glass tube, an even heating may be ensured. This allows a reliable sealing of the heated glass region without deforming regions, which actually have not yet reached the required temperature in the tube.

According to a further exemplary embodiment of the invention, the method comprises the step of vapor depositing an additional layer, in particular an anti-reflection layer, onto an outer surface of the double-walled glass tube before the deforming and air-tight sealing of the glass tube.

For example, the anti-reflection layer may be an MgF₂-layer. However, it is also possible to use other materials for coating the double-walled glass tube within the vacuum chamber.

According to a further exemplary embodiment of the invention, an apparatus for vacuum-tightly sealing a double-walled glass tube having an inner glass tube and an outer glass tube is given. According to a further exemplary embodiment, the apparatus is designed and adapted for conducting the method according to the invention as described herein.

According to a further exemplary embodiment, the apparatus comprises a vacuum chamber for providing a desired negative pressure inside the vacuum chamber. Furthermore, the apparatus comprises a holding element for fixing a double-walled glass tube within the vacuum chamber. Also, the apparatus comprises at least one heating conductor for electro-conductively heating the double-walled glass tube. The apparatus is designed for deforming a double-walled glass tube, which is electro-conductively heated and fixed at the holding element, at an end of the glass tube in a manner, that the first end of the double-walled glass tube is air-tightly sealable.

In other words, the apparatus provides the functionality for heating a double-walled glass tube held and fixed in the apparatus through electrical energy and heat transfer onto the double-walled glass in a vacuum/negative pressure in a manner that it will be mechanically deformable and to press the double-walled tube together, e.g. through a motion of the heating conductor. The apparatus is therefore designed for deforming this tube end and to seal it in air-tight manner. Afterwards, the heating conductor may be removed from the double-walled glass tube, such that the cooling process can be established.

In doing so it is possible in this and each other exemplary embodiment that the apparatus comprises such a double-walled glass tube. However, the apparatus will be described based on its functionality with the double-walled glass tube, through which the structural and functional features and characteristics of the apparatus are provided.

According to a further exemplary embodiment of the invention, the apparatus comprises a first partial cylinder jacket as a first heating conductor and comprises a second partial cylinder jacket as a second heating conductor. Hereby, both partial cylinder jackets are designed for a direct and form-fitting contacting and covering of an outer glass tube of a double-walled glass tube fixed by the holding element.

This exemplary embodiment may be gathered from the further detailed exemplary embodiment of FIG. 3. FIG. 4 also shows such a feature of this exemplary embodiment mentioned here.

According to a further exemplary embodiment, the apparatus comprises a first pneumatic device and a second pneumatic device. Hereby, the first pneumatic device is designed for moving the first heating conductor in direction of the second heating conductor. The second pneumatic device is designed for moving the second heating conductor in direction of the first heating conductor.

In other words, a relative motion between the double-walled glass tube and both heating conductors is created by means of the pneumatic devices in such a manner that the designed sealing by means of the desired deforming of the outer and/or inner glass wall is accomplishable. Hereby, in this and in all other exemplary embodiments, the apparatus may be adapted to different glass tubes. For example, the distances of the heating conductors used may be reduced or increased, such that different diameters of different glass tubes may be processed.

According to a further exemplary embodiment of the invention, the heating conductor is designed for conducting a motion during the electro-conductive heating such that the deforming and the sealing of the double-walled glass tube is accomplished.

Hereby, the heating conductor may also be designed to conduct a motion after a heating. The motion may be accomplished through different mechanical and/or electrical drives. For example, the heating conductor may be controlled to provide a translational motion, such that the glass tube is pressed together.

According to a further exemplary embodiment of the invention, the holding element of the apparatus is provided through the at least one heating conductor. Preferably, the holding element is realized in form of a partial cylinder jacket.

In other words, the heating conductor in this exemplary embodiment provides both the functionality of fixing the double-walled glass tube as well as the electro-conductive heating of the glass tube. As can be gathered from FIG. 3 as an example, here the glass tube may rest on the lower partial cylinder shaped heating conductor and is held therewith. At the same time, the double-walled glass tube experiences a further fixing through the upper partial cylinder shaped heating conductor, by means of which a stability during the process is achieved.

According to a further exemplary embodiment, the apparatus comprises a power supply unit, which works with a working voltage of 20 to 400 V. The power supply unit is a DC power source. In other words, the glass tube is heated through the heating conductor/conductors at a working voltage of 20 to 400 V.

According to a further exemplary embodiment, the apparatus comprises an AC power unit as a power supply unit. This is particularly suggested in case of higher voltage levels are desired. Hereby, possible plasma arcs may be reduced.

### BRIEF DESCRIPTION OF THE DRAWINGS

The various embodiments will hereinafter be described in conjunction with the following drawing figures, wherein like numerals denote like elements, and:

FIG. 1 shows a schematic illustration of a flow-chart of a method for vacuum-tightly sealing a double-walled glass tube according to an exemplary embodiment of the invention.

FIG. 2 shows a cross-section through a part of an apparatus for vacuum-tightly sealing a double-walled glass tube according to an exemplary embodiment of the invention.

FIG. 3 shows an apparatus for vacuum-tightly sealing a double-walled glass tube according to an exemplary embodiment of the invention.

FIG. 4 shows a further exemplary embodiment of an apparatus for vacuum-tightly sealing a double-walled glass tube.

Embodiments of the invention will be explained in more detail once again under reference to the attached figures based on schematic illustrations of preferred exemplary embodiments. Here, further details and advantages of the invention are apparent.

The illustrations in the figures are only schematic and not to scale. In the figure descriptions, same reference numerals are used for identical or similar elements.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

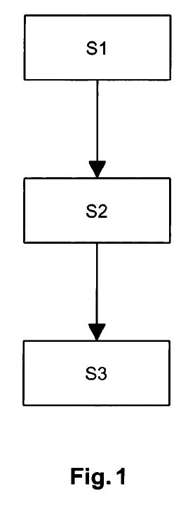

The method of FIG. 1 is a method for vacuum-tightly sealing of a double-walled glass tube and may particularly be considered as a manufacturing method or a part of a manufacturing method for manufacturing of solar collectors. In FIG. 1 the providing of the double-walled glass tube within a vacuum chamber at a desired negative pressure inside the vacuum chamber is shown with step S1. Such a glass tube may be considered as a solar collector. In step S2, the outer and/or the inner glass tube may be heated electro-conductively, namely at a first end of the double-walled glass tube. This is accomplished by means of at least one heating conductor. The deforming of the electro-conductively heated glass tube at the first end of the double-walled glass tube is accomplished in a manner that the outer glass tube and the inner glass tube touch each other and thereby the first end of the double-walled glass tube is sealed in an air-tight manner. This step of deforming and sealing is shown in FIG. 1 as step S3.

In this regard it is to be noted that this exemplary embodiment may be supplemented by different steps explained before and in the following. For example, a relative motion between the double-walled glass tube and the heating conductor may be created, by means of which the double-walled glass tube is deformed and sealed at the first end. Likewise, a volume arranged between the inner and the outer glass tube, may be evacuated. Additionally or alternatively, a rotational motion of the double-walled glass tube relative to the heating conductor may be created. For example, this may be accomplished through a roller device, which is also part of a respective vacuum chamber of an apparatus according to the invention. The method according to FIG. 1 allows heating and sealing of both glass tubes through direct application of the heating conductor, in particular of a ceramics heating conductor and allows a direct heat transfer onto the surface of the glass tubes directly after the evacuation process. For example, the deformation may be accomplished through shifting the respective heating conductors relative to each other. Furthermore, it is possible to vapor deposit absorption layers in a separated chamber section. Hereby, the method of FIG. 1 allows reduction of evacuation times and resultantly a more economic production course. Furthermore, a simple installation in the vacuum chamber is possible. Merely the power supply of the heating conductor into the vacuum zone is required. A direct heat transfer onto the double-walled glass tube and thus a quick process control is enabled by the method of FIG. 1.

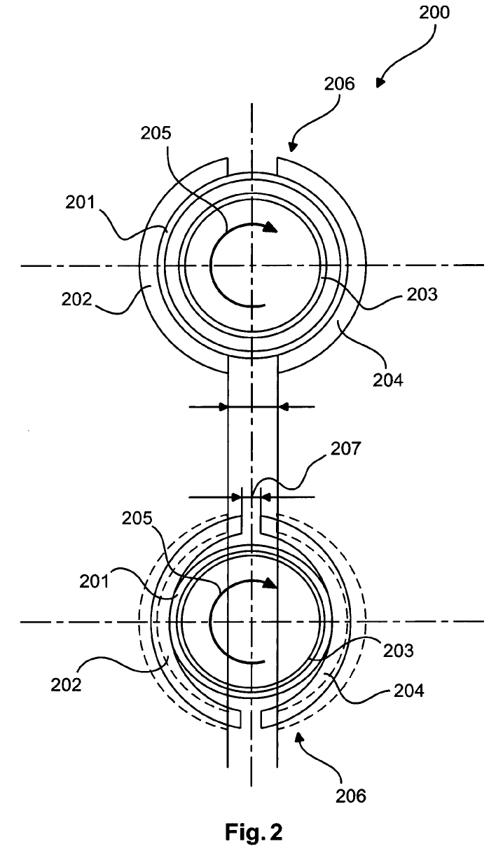

FIG. 2 shows a part of an apparatus 200 for vacuum-tightly sealing a double-walled glass tube 206. In this regard, FIG. 2 in an upper part shows the state of the double-walled glass tube 206 and the respective contacting with the heating conductor 202, 204 before a deforming and before the sealing of the double-walled glass tube. Contrary thereto in the lower part of FIG. 2, the double-walled glass tube 206 is shown after the deforming and after the air-tight sealing of the glass tube. Both heating conductors 202, 204 of the example of FIG. 2 are designed in a manner that their contour receives the glass tube 206 to be sealed, in particular the outer partial tube 201 in a form-fit manner. The double-walled glass tube is partially enclosed in its circumference by both heating conductors; and at the contacting surface the desired heat transfer is accomplished. Hence, hereby a form-fit between both heating conductors and the outer glass tube of the double-walled glass tube is created, such that a particularly good heat conduction from the heating conductor onto the glass tube is possible. FIG. 2 shows the outer glass tube 201 and the inner glass tube 203 in a cross-section. Also, a first heating conductor 202 and a second heating conductor 204 are shown in the upper part of FIG. 2 in a heating position each, i.e. in contact with the double-walled glass tube 206. Hereby, arrow 205 indicates that a relative motion, in particular a relative rotation between the heating conductors 202, 204 and the double-walled glass tube 206 is created.

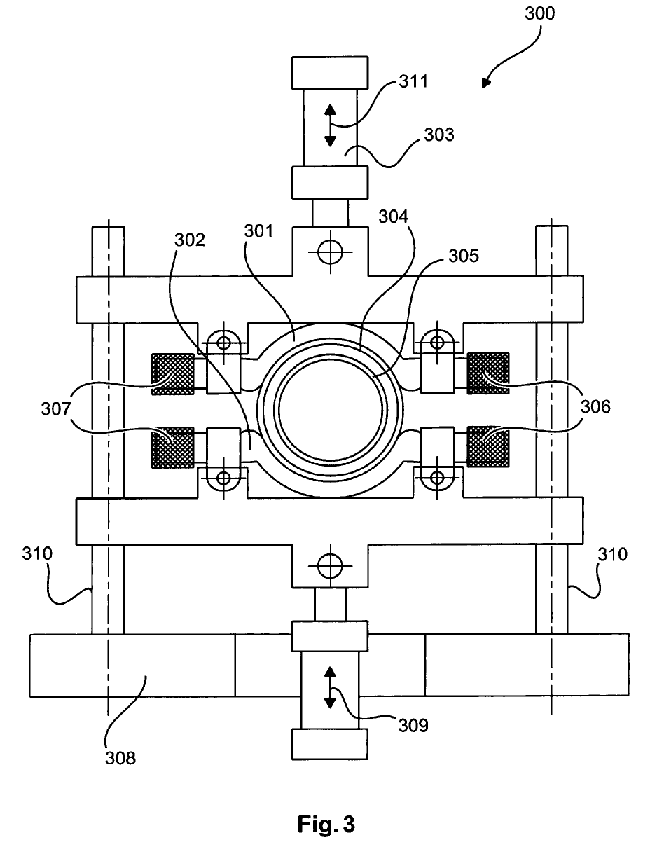

In the lower part of FIG. 2, the outer glass tube 201 is shown after the deforming and also the inner glass tube 203 is shown after the deforming. Also, in the lower part of FIG. 2, the first heating conductor 202 is shown in a deforming position and also the second heating conductor 204 is shown in a deforming position in FIG. 2. In other words, this apparatus is designed for deforming an electro-conductively heated, double-walled glass tube 206 at an end of the glass tube, which glass tube is fixed at the holding element (not shown in FIG. 2), by means of the heating conductors 202, 204, such that the first end of the double-walled glass tube is sealed in an air-tight manner. This state is shown in the lower part of FIG. 2. In this regard it is to be noted, that the first heating conductor 202 in its position in the upper part of FIG. 2 is identical with the heating conductor 202 in the deforming position in the lower part of FIG. 2. The same applies for the second heating conductor 204 shown in the upper picture and the second heating conductor 204 shown in the lower picture of FIG. 2. The apparatus 200 is designed for creating a relative motion between the double-walled glass tube and the heating conductors 202, 204, by means of which the deforming of the double-walled glass tube at the first end is caused. Hereby, in the lower part of FIG. 2 it is shown with reference numeral 207, that due to the shifting of both heating conductors at the end of the method, these are positioned closer to each other in comparison to the beginning of the method as shown in the upper part of FIG. 2. In this example of FIG. 2, both heating conductors are moved to each other in a radial direction each. These may exemplarily be realized through a hydraulic or pneumatic mechanics for creating the motion. An exemplary embodiment is discussed in conjunction with FIG. 3.

FIG. 3 shows a further exemplary embodiment of an apparatus 300 for vacuum-tightly sealing of a double-walled glass tube. Hereby, the apparatus 300 is described by means of its components and functionalities with the double-walled glass tube, by means of which structural and functional features and characteristics of the apparatus 300 are given. Hereby, the apparatus 300 comprises a first upper heating conductor 301 for the outer tube and is shown in a heating position in FIG. 3. Likewise, the apparatus 300 comprises a lower heating conductor for the outer tube, which is also shown in a heating position. The apparatus comprises an upper pneumatic cylinder 303, by means of which a vertical motion of the upper heating conductor is creatable. This translational motion is indicated with the arrow 311 in FIG. 3. The outer glass tube is shown with 304 and the inner glass tube is shown with 305 in FIG. 3. Also, electric connectors 306 and 307 are arranged on the right and left side of the apparatus 300. As can be gathered from FIG. 3, the lower heating conductor 302 is realized in form of a partial cylinder jacket and provides a holding element for the double-walled glass tube. Also, the upper heating conductor 301 fixes the position of the double-walled glass tube. The lower pneumatic cylinder 309 enables a translational motion of the lower heating conductor in analogy to the upper pneumatic cylinder 303. Thereby, a base plate 308 is present in the apparatus 300, on which guide poles 310 are arranged laterally, which guide the translational motions of the heating conductors, which are created by the pneumatic cylinders 303 and 309. According to a further formed exemplary embodiment of the apparatus of FIG. 3, a roller guide is present in the apparatus 300, which is able to create a rotation of the double-walled glass tube during the heating. A respective electrical control of all components, in particular the pneumatic cylinder and the rotation device, may also be included. Furthermore, it can be gathered from FIG. 3 that both partial cylinder jackets in form of the first and the second heating conductors are in a direct and form-fitting contact and are covering of the outer glass tube. Altogether, the apparatus enables the reduction of evacuation time during the manufacturing of solar collectors, in particular of the vacuum-tight sealing of the double-walled glass tube, which is used as a solar collector.

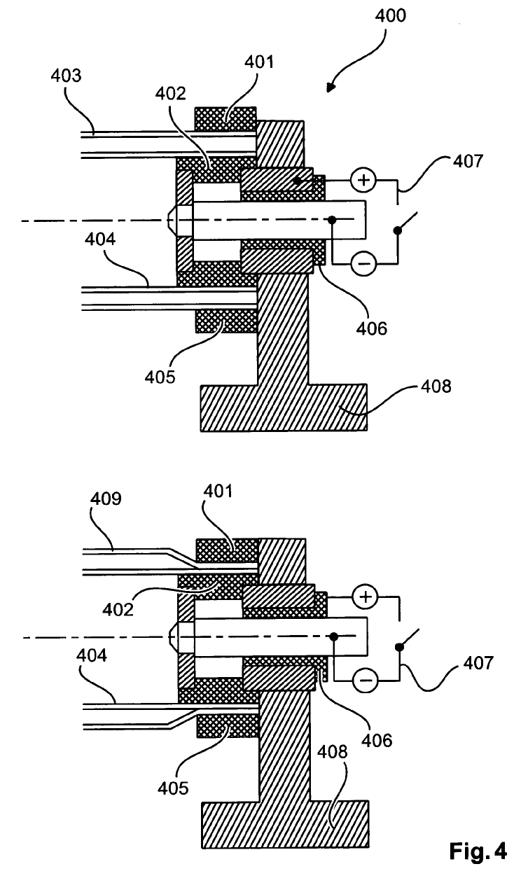

FIG. 4 shows a further exemplary embodiment of an apparatus 400 for vacuum-tightly sealing of a double-walled glass tube. The apparatus 400 comprises an upper heating conductor 401 for the outer tube and a heating conductor 402 for the inner tube. Hereby, the outer tube is referred to with 403 and the inner tube is referred to with 404. Likewise, the lower heating conductor 405 for the outer tube 403 is shown in FIG. 4. Bushing 406 is used for insulation. The bushing 406 has the function of an electrical insulator. The user of the invention may choose the material of the bushing 406 according to the requirements. Due to the relatively high process temperatures, insulators exemplarily made of a plastics material are mostly not to be considered. Oxide ceramics materials are very suitable, such as aluminum oxide, zirconium oxide, yttrium oxide, silicon dioxide or mixtures thereof. In addition to that, the substance class of aluminosilicates are to be considered, e.g. mullite and cordierite. The power supply unit 407 is preferably realized as DC power source/DC current process. Due to possible plasma arcs about 800 V should not be exceeded. In some cases, voltages higher than 800 V are possible. Working voltages suitable for the process are in a range of 20 to 400 V depending on the specific resistance of the heating conductor, the cross-sectional surface and the length. The realization as an AC power unit is also possible and suggested in case of higher desired voltage levels. Hereby, possible plasma arcings may be reduced.

The apparatus 400 of FIG. 4 comprises a console 408 made of a mineral material, which is electrically insulating up to 1400° C. Thereby, different materials may be used. In this regard, the upper, previously described part of FIG. 4 is the state of the apparatus according to the invention within the heating phase. In the lower part of FIG. 4, the state of the apparatus 400 according to the invention within the deforming phase is shown. Hereby, the outer tube 409 is illustrated in its deformed configuration. Also, the upper heating conductor is illustrated for the outer tube 401 in a position moved downward. The heating conductor for the inner tube 402 is also illustrated in the lower part as well as the inner tube 404 and the lower heating conductor 405 for the outer tube. The console 408 is also illustrated in the lower part of FIG. 4. The same applies for the bushings 406 and system 407.

The present invention is applicable for different kinds of methods for vacuum-tightly sealing of a double-walled glass tube in general and is not limited to the given combination of features of claim 1 and the dependent claims. In addition to this, further options arise, to combine single features, if they are derivable from the patent claims, the description of the exemplary embodiments or directly from the drawing.

In addition, it should be pointed out that “comprising” does not exclude other elements or steps, and “a” or “an” does not exclude a plural number. Furthermore, it should be pointed out that characteristics or steps which have been described with reference to one of the above exemplary embodiments may also be used in combination with other characteristics or steps of other exemplary embodiments described above. Reference characters in the claims are not to be interpreted as limitations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

What is claimed is:

1. A method for sealing a double-walled glass tube in a vacuum-tight manner, the glass tube having an inner glass tube and an outer glass tube, the method comprising the steps of:
providing the double-walled glass tube inside a vacuum chamber at a desired negative pressure inside the vacuum chamber;
electro-conductively heating the outer and/or inner glass tube at a first end of the double-walled glass tube by means of at least one heating conductor; and
deforming the electro-conductively heated glass tube at the first end such that the outer glass tube and the inner glass tube touch each other and such that the first end of the double-walled glass tube is sealed in a gas-tight manner.

2. The method according to claim 1, wherein the electro-conductively heating and the deforming are conducted through the at least one heating conductor within the vacuum chamber.

3. The method according to claim 1, further comprising the step of:
creating a relative motion between the double-walled glass tube and the heating conductor, through which the deforming of the double-walled glass tube at the first end is caused.

4. The method according to claim 1, wherein at least two heating conductors are used, and wherein the method further comprises the steps of:
at least partially covering the outer glass tube by means of the first heating conductor;
at least partially covering the outer glass tube by means of the second heating conductor; and
displacing both heating conductors perpendicular to a longitudinal axis of the double-walled glass tube for deforming and air-tight sealing of the electro-conductively heated glass tube.

5. The method according to claim 1, wherein the heating conductor comprises a ceramic material.

6. The method according to claim 5, wherein the heating conductor comprises silicon infiltrated silicon carbide (SiSiC).

7. The method according to claim 1, wherein the electro-conductively heating is accomplished through direct application of the heating conductor onto a surface of the double-walled glass tube and after an evacuation process of the vacuum chamber.

8. The method according to claim 1, further comprising the step of:
evacuating a volume, which is arranged between the inner glass tube and the outer glass tube.

9. The method according to claim 1, further comprising the step of:
creating a rotational movement of the inner and outer glass tube during the electro-conductively heating relative to the heating conductor.

10. The method according to claim 1, further comprising the step of:
vapor depositioning of an extra layer onto an outer surface of the double-walled glass tube before deforming and air-tight sealing of the glass tube.

11. The method according to claim 10, wherein the extra layer comprises an antireflection coating.

12. An apparatus for vacuum-tight sealing of a double-walled glass tube having an inner glass tube and an outer glass tube, the apparatus comprising:
a vacuum chamber for providing a desired negative pressure inside the vacuum chamber;
a holding element for fixing a double-walled glass tube inside the vacuum chamber; and
at least one heating conductor for electro-conductively heating the double-walled glass tube;
wherein the apparatus is configured to deform a double-walled glass tube, that is fixated at the holding element and electro-conductively heated through the heating conductor, at an end of the glass tube, such that the first end of the double-walled glass tube is sealable in an air-tight manner.

13. The apparatus according to claim 12, further comprising:
a first partial cylinder barrel as a first heating conductor; and
a second partial cylinder barrel as a second heating conductor;
wherein both partial cylinder barrels are designed for a direct and form-fitting contacting and covering an outer glass tube of a double-walled glass tube fixated by the holding element.

14. The apparatus according to claim 13, further comprising:
a first pneumatic device; and
a second pneumatic device;
wherein the first pneumatic device is configured to move the first heating conductor in the direction of the second heating conductor; and
wherein the second pneumatic device is configured to move the second heating conductor in the direction of the first heating conductor.

15. The apparatus according to claim 12, wherein the heating conductor is designed for conducting a motion during the electro-conductive heating to deform and seal the double-walled glass tube.

16. The apparatus according to claim 12, wherein the holding element is provided by the at least one heating conductor, in a form of a second partial cylinder barrel.
